(19) United States
(12) Patent Application Publication
(10) Pub. No.: US 2020/0410145 A1
(43) Pub. Date: Dec. 31, 2020

(54) METHOD FOR CALCULATING VOLTAGE STABILITY MARGIN OF POWER SYSTEM CONSIDERING THE COUPLING OF ELECTRIC-GAS SYSTEM

(71) Applicant: Tsinghua University, Beijing (CN)

(72) Inventors: Hongbin SUN, Beijing (CN); Qinglai GUO, Beijing (CN); Bin WANG, Beijing (CN); Zheng QIAO, Beijing (CN); Boming ZHANG, Beijing (CN); Wenchuan WU, Beijing (CN); Mingye ZHANG, Beijing (CN)

(21) Appl. No.: 17/021,445

(22) Filed: Sep. 15, 2020

Related U.S. Application Data
(63) Continuation of application No. PCT/CN2018/113635, filed on Nov. 2, 2018.

(30) Foreign Application Priority Data
Apr. 16, 2018 (CN) 201810335838.4

(51) Int. Cl. G06F 30/20; H02J 3/38

(52) U.S. Cl. CPC G06F 30/20; G06F 2111/10; H02J 2203/20; H02J 3/381

(57) ABSTRACT

A method for calculating a voltage stability margin of a power system considering electric-gas system coupling is provided. The method includes: establishing constraint equations for stable and secure operation of an electric-gas coupling system; establishing a continuous energy flow model of the electric-gas coupling system using a load margin index λ based on a correlation between an electric load of the power system and a natural gas load of the natural gas system; setting inequality constraints for the stable and secure operation of the electric-gas coupling system based on the limits of pressure and gas supply amount of the natural gas system; and solving the energy flow equation established based on the constraints and the continuous energy flow model to obtain the voltage stability margin of the power system considering electric-gas system coupling.

### CROSS-REFERENCE TO RELATED APPLICATION

The present application is a continuation of International Application No. PCT/CN2018/113635, filed on Nov. 2, 2018, which claims priority to Chinese Patent Application No. 201810335838.4, filed on Apr. 16, 2018, the entire disclosures of which are incorporated herein by reference.

### FIELD

The present disclosure relates to a method for calculating a voltage stability margin of a power system considering electric-gas system coupling, which belongs to a technical field of security analysis and evaluation in the power system considering the coupling characteristics of multi-energy flow.

### BACKGROUND

Due to the huge advantages of gas generators such as low cost, low environmental damage, fast response speed, and short construction period of gas-fired plants, natural gas has become an important part of fuel worldwide. Therefore, as the proportion of natural gas in the primary energy supply of the power system is increasing, the reliable supply of natural gas plays a vital role in the security of the power system.

However, natural gas is different from energy sources like coal that can be stored in a large scale, which is supplied by long-distance transmission through pipelines. On the one hand, due to pressure security constraints, the natural gas flow through pipelines is limited. On the other hand, the natural gas load fluctuates during the year, month, and day. In many national regulations, other commercial and civil natural gas loads have a higher priority than the gas-fired power plants. Therefore, the gas supply of the power system is limited by the pipeline transmission capacity of the natural gas system and other natural gas loads. The voltage stability margin calculation method that only considers the power system constraints is no longer applicable. It is urgent to propose a new method for calculating a voltage stability margin considering electric-gas system coupling.

### SUMMARY

The present disclosure aims to solve the technical problems in the related art at least to some extent.

An objective of the present disclosure is to propose a method for calculating a voltage stability margin of a power system considering electric-gas system coupling.

According to embodiments of the present disclosure, the method for calculating a voltage stability margin of a power system considering electric-gas system coupling may include: establishing constraint equations for stable and secure operation of an electric-gas coupling system, in which the electric-gas coupling system comprises a power system and a natural gas system coupled through gas turbines; establishing a continuous energy flow model of the electric-gas coupling system using a load margin index λ based on a correlation between the electric load and natural gas load; setting inequality constraint conditions for the stable and secure operation of the electric-gas coupling system based on the limits of pressure and gas supply amount of the natural gas system; and solving the energy flow model established based on the constraints and the continuous energy flow model to obtain the voltage stability margin of the power system considering electric-gas system coupling.

### DETAILED DESCRIPTION

The embodiments of the present disclosure described in detail below are exemplary, which are intended to explain the present disclosure, but should not be construed as limiting the present disclosure.

Embodiments of the present disclosure propose a method for calculating a voltage stability margin of a power system considering electric-gas system coupling, so as to avoid potential risks of optimistic results of the voltage stability margin calculation without considering the security constraints of the natural gas system and the influence of the natural gas load.

The power system voltage stability margin calculation method considering electric-gas system coupling proposed by the present disclosure includes the following steps:

(1) establishing constraint equations for stable and secure operation of an electric-gas coupling system, including:

(1-1) establishing a power flow equation of a power system in the electric-gas coupling system, which is represented by:

$${P}_{Gi} - {P}_{Li} - {V}_{i} {\sum }_{j ∈ i} {V}_{j} ( {G}_{ij} cos {θ}_{ij} + {B}_{ij} sin {θ}_{ij} ) = 0 , i = 1 , 2 , … , {N}_{e} - 1$$

$${Q}_{Gi} - {Q}_{Li} - {V}_{i} {\sum }_{j ∈ i} {V}_{j} ( {G}_{ij} sin {θ}_{ij} - {B}_{ij} cos {θ}_{ij} ) = 0 , i = 1 , 2 , … , {N}_{PQ} ,$$

where P_{Gi} represents the input active power of an i-th node in the power system, P_{Li} represents the output active power of the i-th node in the power system, Q_{G}, represents the input reactive power of the i-th node in the power system, Q_{Li} represents the output reactive power of the i-th node in the power system, Vᵢ and Vⱼ represent voltage amplitudes of the i-th node and a j-th node in the power system respectively, and θᵢ and θⱼ represent voltage phase angles the i-th node and the j-th node in the power system, Gᵢⱼ represents the conductance corresponding to an i-th row and a j-th column in a node admittance matrix Y of the power system, and Bᵢⱼ represents a susceptance corresponding to the i-th row and j-th column in the node admittance matrix Y of the power system, the node admittance matrix Y of the power system is obtained from a power system dispatch center, Nₑ represents the number of all nodes in the power system, and N_{PQ} represents the number of PQ nodes of the power system with a given active power P and reactive power Q;

(1-2) establishing a hydraulic equation of a pipeline in a natural gas system in the electric-gas coupling system, which is represented by:

fₖₘ=sgnₚ(pₖ,pₘ)×Cₖₘ×\sqrt{(pₖ²−pₘ²)},

where fₖₘ represents the natural gas volume flow in a pipeline between a k-th node and an m-th node in the natural gas system, Pₖ, pₘ represent the pressure of the k-th node and the m-th node respectively, Cₖₘ represents the resistance coefficient of the pipeline km between the k-th node and the m-th node, which is obtained from a design report of the pipeline, and in the hydraulic equation of a pipeline in the natural gas system, when (pₖ²−pₘ²)≥0, sgnₚ(pₖ, pₘ)=1, and when (pₖ²−pₘ²)<0, sgnₚ(pₖ, pₘ)=1;

(1-3) establishing a coupling equation between the power system and the natural gas system in the electric-gas coupling system which are coupled through gas turbines, which is represented by:

μ_{G}×L_{G}λH_{gas}=P_{G},

where L_{G} represents the gas load of the gas turbine, P_{G} represents the active power output of the gas turbine, H_{gas} represents the combustion calorific value of natural gas, with a value of 37.59 MJ/m3, and μ_{G} represents the efficiency coefficient of the gas turbine, which is obtained from a manual of the gas turbine;

(1-4) establishing a node gas flow balance equation of the natural gas system in an electric-gas coupling system, which is represented by:

$${\sum }_{k ∈ m} {f}_{km} = {L}_{s m} - {L}_{L m} ,$$

where Lₛₘ, represents the input volume flow rate of the m-th node in the natural gas system, and L_{Lm} represents the output volume flow rate of the m-th node in the natural gas system;

(2) selecting a load margin index λ as a voltage stability margin index, and selecting a load growth method from: a) a first method, in which original power factors of an active power and a reactive power of a single load increase while other loads remaining unchanged; b) a second method, in which original power factors of active powers and reactive powers of loads in a selected area increase while other loads remaining unchanged; c) a third method, in which original power factors of active powers and reactive powers of all loads increase;

(3) establishing a continuous energy flow model of the electric-gas coupling system using the load margin index λ, including:

(3-1) establishing variation equations for input and output power of the power system in the electric-gas coupling system, which are represented by:

P_{Li}(λ)=(1+λ)P_{Li0}, P_{G1}(λ)=(1+ξ)P_{Gi0}, i=1, 2, . . . , Nₑ−1

Q_{Li}(λ)=(1+λ)Q_{Li0}, i=1, 2, . . . , N_{PQ},

where P_{Li0} represents the output active power of the node i at the initial moment, P_{Gi0} represents the input active power of the node i at the initial moment, Q_{Li0} represents the input reactive power of the node i at the initial moment,

$$ξ = ( {\sum }_{i = 1}^{{N}_{e}} {P}_{Li 0} / {\sum }_{i = 1}^{{N}_{e}} {P}_{Gi 0} ) λ , {N}_{e}$$

represents the number of nodes in the power system, N_{PQ} represents the number of PQ nodes in the power system;

(3-2) establishing variation equations for a natural gas load in the natural gas system in the electric-gas coupling system, which is represented by:

L_{Lm}(λ)=(1+rλ)L_{Lm0},

where L_{Lm0} represents the output volume flow of the m-th node at the initial moment, which is obtained from operation data of the natural gas system; r represents the correlation coefficient between a power system gas load and a natural gas system load, which is related to region, climate, seasons and so on, and is obtained from data of a local energy statistics department;

(3-3) substituting the continuous variation equations in steps (3-1) and (3-2) into the equations in steps (1-1) and (1-4) to obtain equations of:

$${P}_{Gi} ( λ ) - {P}_{Li} ( λ ) - {V}_{i} {\sum }_{j ∈ i} {V}_{j} ( {G}_{ij} cos {θ}_{ij} + {B}_{ij} sin {θ}_{ij} ) = 0$$

$${Q}_{Gi} - {Q}_{Li} ( λ ) - {V}_{i} {\sum }_{j ∈ i} {V}_{j} ( {G}_{ij} sin {θ}_{ij} - {B}_{ij} cos {θ}_{ij} ) = 0 , \\ {\sum }_{k ∈ m} {f}_{k m} = {L}_{s m} - {L}_{L m} ( λ ) ,$$

(4) setting inequality constraint conditions for the stable and secure operation of the electric-gas coupling system, including:

(4-1) an output active power P_{gen} of a generator set in the power system being greater than or equal to 0, and being smaller than or equal to the maximum power Pₘₐₓ^{gen} given on a nameplate of the generator set, which is represented by:

0≤P_{gen}≤Pₘₐₓ^{gen},

(4-2) an output reactive power Qᵢ^{gen} of the generator set in the power system being greater than or equal to the minimum power Qₘᵢₙ^{gen} given on the nameplate of the generator set, and being smaller than or equal to the maximum power Pₘₐₓ^{gen} given on the nameplate of the generator set, which is represented by:

Qₘᵢₙ^{gen}≤Q_{gen}≤Qₘₐₓ^{gen},

(4-3) a voltage amplitude Uᵢ of the i-th node of the power system ranging between an upper limit Ūᵢ and a lower limit Uᵢ of a set secure operating voltage of the power system, which is represented by:

Uᵢ≤Uᵢ≤Ūᵢ,

where Uᵢ is 0.9 times or 0.95 times of a rated voltage of the i-th node, and Ūᵢ is 1.1 times or 1.05 times of the rated voltage of the i-th node;

(4-4) a pressure pₖ of the k-th node in the natural gas system ranging between an upper limit p̅ₖ and a lower limit pₖ of a set pipeline secure operating pressure, which is represented by:

pₖ≤pₖ≤p̅ₖ,

(4-5) a gas supply amount Lₛ of a gas source in the natural gas system being greater than or equal to 0, and being smaller than or equal to the maximum value L_{s,max} of a natural gas flow that the gas source can provide, which is represented by:

0<Lₛ<L_{s,max},

(5) using an optimization method (such as an interior point method) or an iterative method (such as Newton method) to solve the energy flow equation F(X) constructed from step (1) and step (3-3) when λ is 0, and obtaining an initial energy flow solution Xₜ(Vₜ,θₜ,λₜ), where the subscript t represents a current calculation point;

(6) obtaining a tangent vector dXₜ(dVₜ,dθₜ,dλₜ) from the initial solution Xₜ, setting a step length h of a change of the energy flow solution to obtain a predicted value Xₜ₊₁′(Vₜ₊₁′,θₜ₊₁′,λₜ₊₁′), where the subscript t+1 represents a next calculation point, which are represented by:

$$\frac{\partial F}{\partial X} {\vert}_{X = {X}_{t}} \cdot dX = 0 , \\ {X}_{t + 1}^{′} = {X}_{t} + h \cdot {dX}_{t} ;$$

(7) taking Xₜ₊₁′ as an initial point, recalculating the energy flow equation constructed from the step (1) and step (3-3) to obtain a correction value Xₜ₊₁, and determining whether Xₜ₊₁ satisfies the constraints in step (4) and dλₜ>0, if both the constraints of step (4) and dλₜ>0 are met, taking Xₜ₊₁ as an initial solution Xₜ, and returning to step (6); if the constraint of step (4) is not satisfied or dλₜ>0 is not satisfied, determining whether Xᵢ₊₁ satisfies dλₜ/λₜ<ε and dλₜ>0, if dΔₜ/λₜ<ε and dλₜ>0 are not satisfied, readjusting the step length h and returning to step (6), and if dλₜ/λₜ<ε and dλₜ>0 are satisfied, outputting λ at this time as a voltage stability margin considering constraints of the electric-gas coupling system.

The present disclosure relates to a power system voltage stability margin calculation method considering electric-gas system coupling, having characteristics and effects described below.

The method of the present disclosure fully considers the tight coupling between the power system and the natural gas system, and obtains the voltage stability margin of the power system in the coupled system. On one hand, the impact of the security and capacity constraints of the natural gas system on the power system is taken in to consideration. On the other hand, it also considers the influence of the correlation between the electric power load and the natural gas load on the voltage stability margin according to the actual situation of the application area, avoiding optimistic results of traditional calculation methods by simply considering the constraints of the power system. This method can be used in the operation risk analysis of the power system to provide risk assessment indicators for the operation and management personnel of the power system, which is beneficial to reduce potential risks and improve the security of system operation.

In the description of this specification, descriptions with reference to the terms “one embodiment”, “some embodiments”, “examples”, “specific examples”, or “some examples” etc. mean specific features described in conjunction with the embodiment or example, structure, materials or features are included in at least one embodiment or example of the present disclosure. In this specification, the schematic representations of the above terms do not necessarily refer to the same embodiment or example. Moreover, the described specific features, structures, materials, or characteristics can be combined in any one or more embodiments or examples in an appropriate manner. In addition, those skilled in the art can combine and combine the different embodiments or examples and the features of the different embodiments or examples described in this specification without contradicting each other.

In addition, the terms “first” and “second” are only used for descriptive purposes, and cannot be understood as indicating or implying relative importance or implicitly indicating the number of indicated technical features. Therefore, the features defined with “first” and “second” may explicitly or implicitly include at least one of the features. In the description of the present disclosure, “a plurality of” means at least two, such as two, three, etc., unless otherwise specifically defined.

The scope of the preferred embodiment of the present disclosure includes additional implementations, which may not be in the order shown or discussed, including performing functions in a substantially simultaneous manner or in reverse order according to the functions involved. It is understood by those skilled in the art to which the embodiments of the present disclosure belong.

A person of ordinary skill in the art can understand that all or part of the steps carried in the method of the foregoing embodiments can be implemented by a program instructing relevant hardware to complete. The program can be stored in a computer-readable storage medium. When executed, it includes one of the steps of the method embodiment or a combination thereof.

Although the embodiments of the present disclosure have been shown and described above, it can be understood that the above-mentioned embodiments are exemplary and should not be construed as limiting the present disclosure. Those of ordinary skill in the art can comment on the above-mentioned embodiments within the scope of the present disclosure. The embodiment undergoes changes, amendments, substitutions and modifications.

What is claimed is:

1. A method for calculating a voltage stability margin of a power system considering electric-gas system coupling, comprising:
establishing constraint equations for stable and secure operation of an electric-gas coupling system, wherein the electric-gas coupling system comprises the power system and a natural gas system coupled through gas turbines;
establishing a continuous energy flow model of the electric-gas coupling system using a load margin index λ based on a correlation between the electric load and the natural gas load of the natural gas system;
setting inequality constraints for the stable and secure operation of the electric-gas coupling system based on the limits of pressure and gas supply amount of the natural gas system; and
solving an energy flow equation established based on the constraints and the continuous energy flow model to obtain the voltage stability margin of the power system considering electric-gas system coupling.

2. The method of claim 1, wherein establishing the constraint equations for stable and secure operation of the electric-gas coupling system comprises:
(1-1) establishing a power flow equation of the power system in the electric-gas coupling system, which is represented by:
$${P}_{Gi} - {P}_{Li} - {V}_{i} {\sum }_{j ∈ i} {V}_{j} ( {G}_{ij} cos {θ}_{ij} + {B}_{ij} sin {θ}_{J} ) = 0 , \\ i = 1 , 2 , … , {N}_{e} - 1$$
$${Q}_{Gi} - {Q}_{Li} - {V}_{i} {\sum }_{j ∈ i} {V}_{j} ( {G}_{ij} sin {θ}_{ij} - {B}_{ij} cos {θ}_{ij} ) = 0 , \\ i = 1 , 2 , … , {N}_{PQ} ,$$
where P_{Gi} represents an input active power of an i-th node in the power system, P_{Li} represents an output active power of the i-th node in the power system, Q_{Gi} represents an input reactive power of the i-th node in the power system, Q_{Li} represents an output reactive power of the i-th node in the power system, Vᵢ and Vⱼ represent voltage amplitudes of the i-th node and a j-th node in the power system respectively, and θᵢ and θⱼ represent voltage phase angles the i-th node and the j-th node in the power system, Gᵢⱼ represents a conductance corresponding to an i-th row and a j-th column in a node admittance matrix Y of the power system, and Bᵢⱼ represents a susceptance corresponding to the i-th row and j-th column in the node admittance matrix Y of the power system, the node admittance matrix Y of the power system is obtained from a power system dispatch center, Nₑ represents the number of all nodes in the power system, and A N_{PQ} represents the number of PQ nodes of the power system with a given active power P and reactive power Q;
(1-2) establishing a hydraulic equation of a pipeline in the natural gas system in the electric-gas coupling system, which is represented by:
fₖₘ=sgnₚ(pₖ,pₘ)×Cₖₘ×\sqrt{(pₖ²−pₘ²)},
where fₖₘ represents a natural gas volume flow in a pipeline between a k-th node and an m-th node in the natural gas system, pₖ, pₘ represent pressure of the k-th node and the m-th node respectively, Cₖₘ represents a resistance coefficient of the pipeline km between the k-th node and the m-th node, which is obtained from a design report of the pipeline, and in the hydraulic equation of a pipeline in the natural gas system, when (pₖ²−pₘ²)≥0, sgnₚ(pₖ, pₘ)=1, and when (pₖ²−pₘ²)<0, sgnₚ(pₖ, pₘ)=1;
(1-3) establishing a coupling equation between the power system and the natural gas system in the electric-gas coupling system which are coupled through gas turbines, which is represented by:
μ_{G}×L_{G}×H_{gas}=P_{G},
where L_{G} represents the gas load of a gas turbine, P_{G} represents the active power output of the gas turbine, H_{gas} represents a combustion calorific value of natural gas, with a value of 37.59 MJ/m3, and μ_{G} represents an efficiency coefficient of the gas turbine, which is obtained from a manual of the gas turbine;
(1-4) establishing a node gas flow balance equation of the natural gas system in an electric-gas coupling system, which is represented by:
$${\sum }_{k ∈ m} {f}_{km} = {L}_{s m} - {L}_{L m} ,$$
where Lₛₘ represents an input volume flow rate of the m-th node in the natural gas system, and L_{Lm} represents an output volume flow rate of the m-th node in the natural gas system.

3. The method of claim 2, wherein the method further comprises: selecting the load margin index λ as a voltage stability margin index, and selecting a load growth method from: a) a first method, in which original power factors of an active power and a reactive power of a single load increase while other loads remaining unchanged; b) a second method, in which original power factors of active powers and reactive powers of loads in a selected area increase while other loads remaining unchanged; c) a third method, in which original power factors of active powers and reactive powers of all loads increase.

4. The method of claim 3, wherein establishing the continuous energy flow model of the electric-gas coupling system using the load margin index λ comprises:
(3-1) establishing variation equations for input and output power of the power system in the electric-gas coupling system, which are represented by:
P_{Li}(λ)=(1+λ)P_{Li0}, P_{G1}(λ)=(1+ξ)P_{Gi0}, i=1, 2, . . . , Nₑ−1
Q_{Li}(λ)=(1+λ)Q_{Li0}, i=1, 2, . . . , N_{PQ},
where P_{Li0} represents an output active power of the node i at an initial moment, P_{Gi0} represents the input active power of the node i at the initial moment, Q_{Li0} represents the input reactive power of the node i at the initial moment,
$$ξ = ( {\sum }_{i = 1}^{{N}_{e}} {P}_{Li 0} / {\sum }_{i = 1}^{{N}_{e}} {P}_{Gi 0} ) λ , {N}_{e}$$
represents the number of nodes in the power system, N_{PQ} represents the number of PQ nodes in the power system;
(3-2) establishing variation equations for a natural gas load in the natural gas system in the electric-gas coupling system, which is represented by:
L_{Lm}(λ)=(1+rλ)L_{Lm0},
where L_{Lm0} represents an output volume flow of the m-th node at the initial moment, which is obtained from operation data of the natural gas system; r represents a correlation coefficient between a power system gas load and a natural gas system load, which is related to region, climate, seasons, and is obtained from data of a local energy statistics department;
(3-3) substituting the continuous variation equations in steps (3-1) and (3-2) into the equations in steps (1-1) and (1-4) to obtain equations of:
$${P}_{Gi} ( λ ) - {P}_{Li} ( λ ) - {V}_{i} {\sum }_{j ∈ i} {V}_{j} ( {G}_{ij} cos {θ}_{ij} + {B}_{ij} sin {θ}_{ij} ) = 0$$
$${Q}_{Gi} - {Q}_{Li} ( λ ) - {V}_{i} {\sum }_{j ∈ i} {V}_{j} ( {G}_{ij} sin {θ}_{ij} - {B}_{ij} cos {θ}_{ij} ) = 0 , \\ {\sum }_{k ∈ m} {f}_{k m} = {L}_{s m} - {L}_{L m} ( λ ) .$$

5. The method of claim 4, wherein setting the inequality constraint conditions for the stable and secure operation of the electric-gas coupling system, and the inequality constraint conditions comprises:
(4-1) an output active power P_{gen} of a generator set in the power system being greater than or equal to 0, and being smaller than or equal to the maximum power Pₘₐₓ^{gen} given on a nameplate of the generator set, which is represented by:
0≤P_{gen}≤Pₘₐₓ^{gen},
(4-2) an output reactive power Qᵢ^{gen} of the generator set in the power system being greater than or equal to the minimum power Qₘᵢₙ^{gen} given on the nameplate of the generator set, and being smaller than or equal to the maximum power Pₘₐₓ^{gen} given on the nameplate of the generator set, which is represented by:
Qₘᵢₙ^{gen}≤Q_{gen}≤Qₘₐₓ^{gen},
(4-3) a voltage amplitude Uᵢ of the i-th node of the power system ranging between an upper limit Ūᵢ and a lower limit Uᵢ of a set secure operating voltage of the power system, which is represented by:
Uᵢ≤Uᵢ≤Ūᵢ,
where Uᵢ is 0.9 times or 0.95 times of a rated voltage of the i-th node, and Ūᵢ is 1.1 times or 1.05 times of the rated voltage of the i-th node;
(4-4) the pressure pₖ of the k-th node in the natural gas system ranging between an upper limit p̅ₖ and a lower limit pₖ of a set pipeline secure operating pressure, which is represented by:
pₖ≤pₖ≤p̅ₖ,
(4-5) a gas supply amount Lₛ of a gas source in the natural gas system being greater than or equal to 0, and being smaller than or equal to the maximum value L_{s,max} of a natural gas flow that the gas source can provide, which is represented by:
0≤Lₛ≤L_{s,max}.

6. The method of claim 5, wherein solving the energy flow equation established based on the constraint equations and the continuous energy flow model to obtain the voltage stability margin of the power system comprises:
using at least one of an optimization method and an iterative method to solve the energy flow equation F(X) constructed from step (1) and step (3-3) when λ is 0, and obtaining an initial energy flow solution Xₜ(Vₜ,θₜ,λₜ), where the subscript t represents a current calculation point.

7. The method of claim 6, where in the optimization method at least comprises an interior point method, and the iterative method at least comprises Newton method.

8. The method of claim 6, wherein solving the energy flow equation established based on the constraint equations and the continuous energy flow model to obtain the voltage stability margin of the power system comprises:
obtaining a tangent vector dXₜ(dVₜ,dθₜ,dλₜ) from the initial energy flow solution Xₜ, setting a step length h of a change of an energy flow solution to obtain a predicted value Xₜ₊₁′(Vₜ₊₁′,θₜ₊₁′,λₜ₊₁′), where the subscript t+1 represents a next calculation point, which are represented by:
$$\frac{\partial F}{\partial X} {\vert}_{X = {X}_{t}} \cdot dX = 0 , \\ {X}_{t + 1}^{′} = {X}_{t} + h \cdot {dX}_{t} ;$$

9. The method of claim 8, wherein solving the energy flow equation established based on the constraints and the continuous energy flow model to obtain the voltage stability margin of the power system comprises:
taking Xₜ₊₁′ as an initial point, recalculating the energy flow model constructed from the step (1) and step (3-3) to obtain a correction value Xₜ₊₁, and determining whether Xₜ₊₁ satisfies the inequality constraints and a constraint of dλₜ>0, if both the inequality constraints and the constraint of dλₜ>0 are met, taking Xₜ₊₁ as the initial energy flow solution Xₜ, and returning to the step of obtaining the tangent vector dXₜ(dVₜ,dθₜ,dλₜ) from the initial solution Xₜ; if the inequality constraints is not satisfied or the constraint of dλₜ>0 is not satisfied, determining whether Xₜ₊₁ satisfies dλₜ<ε and dλ>ₜ0, if dλₜ/λₜ<ε and dλₜ>0 are not satisfied, readjusting the step length h and returning to step (6), and if dλₜ/λₜ<ε and dλₜ>0 are satisfied, outputting λ at this time as the voltage stability margin of the power system considering electric-gas system coupling.
